(19) United States
(12) Patent Application Publication
(10) Pub. No.: US 2005/0232665 A1
(43) Pub. Date: Oct. 20, 2005

(54) Image forming apparatus, process cartridge, lubrication method, and toner

(76) Inventors: Koike Toshio, Kawasaki city (JP); Ken Amemiya, Tokyo (JP); Masanori Kawasumi, Yokohama city (JP); Yuji Arai, Kawasaki city (JP); Tokuya Ojimi, Kawasaki city (JP); Takaaki Tawada, Yokohama city (JP); Takuzi Yoneda, Tokyo (JP); Takeshi Shintani, Kawasaki city (JP); Masami Tomita, Numazu city (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/090,565

(22) Filed: Mar. 28, 2005

(30) Foreign Application Priority Data
Mar. 26, 2004 (JP) 2004-091310

(51) Int. Cl. G03G 21/00

(52) U.S. Cl. 399/346; 399/350

(57) ABSTRACT

An image forming apparatus is provided having an image carrier, a charging unit, an exposing unit, a developing unit, a transfer unit, a cleaning mechanism, and an application mechanism, in which the developing unit supplies a toner, free from zinc and having an average circularity of at least 0.93, to the latent image to make visible the latent image, and wherein the cleaning mechanism cleans the image carrier, and the application mechanism applies a lubrication agent preferably formed of zinc stearate on the image carrier, such that the zinc amount on the surface of the image carrier after a cleaning process and an application process is from 0.4 to 2.5 atm %.

### BACKGROUND OF THE INVENTION

1. Field of the Invention

The present invention relates to an image forming apparatus using electro-photography process, and more particularly to an image forming apparatus including an application unit for applying a lubrication agent on a surface of an image carrier, such as a photoconductive member, to reduce a friction coefficient of the surface of the image carrier, a process cartridge having the application unit, a lubrication method, and toner used in the image forming apparatus.

2. Discussion of the Background

An electrophotographic image forming apparatus conventionally includes a photoconductive member as an image carrier. In the image forming apparatus, a surface of the photoconductive member is charged by electric discharge. The charged photoconductive member's surface is exposed with light to form an electrostatic latent image on the photoconductive member's surface. Toner is applied to the photoconductive member's surface to develop, or make visible, the electrostatic latent image. The visible image formed on the photoconductive member's surface is transferred and fused on a surface of a transfer sheet. Then, the transfer sheet is ejected from the image forming apparatus.

After transferring the visible image to the transfer sheet, some materials, such as non-transferred toners, remain on the photoconductive member's surface. To avoid such materials affecting the next image forming process, the photoconductive member's surface is cleaned by a cleaning mechanism, and is prepared for the next image forming process.

A typical cleaning mechanism includes a cleaning blade, made of an elastic material, such as rubber. The cleaning blade contacts the photoconductive member's surface to remove deposits, such as non-transferred toner, from the photoconductive member.

An increased recent-demand on high image quality has accelerated studies on toner particle size (i.e., smaller diameter toner) and particle shape (i.e., highly spherical toner) to realize higher precise color image formation. Smaller diameter toners lead to increased dot-reproducibility, and highly spherical toners lead to increased image-developability and transferability.

Because conventional mixing and grinding methods experience hardships in production of such smaller diameter toners and highly spherical toners, polymerization methods such as suspension polymerization, emulsion polymerization, and/or dispersion polymerization have been employed for producing toners having smaller diameter and higher sphericity.

However, when highly spherical toners and smaller diameter toners are used for image forming, some drawbacks have also been observed on cleaning of the photoconductive member after image forming. One of the drawbacks is a lower cleanability of highly spherical toners and smaller diameter toners when a typical blade cleaning method is used.

The cleaning blade scrapes the photoconductive member's surface to remove toners from the photoconductive member's surface. When an edge of the cleaning blade contacts the photoconductive member's surface, the edge of the cleaning blade deforms due to friction between the cleaning blade and the photoconductive member, and this deformation may lead to formation of tiny spaces between the photoconductive member and the cleaning blade.

Toners having smaller diameter and higher sphericity have a lower rolling-friction coefficient. When these toners roll in the tiny spaces formed between the photoconductive member and the cleaning blade, the toners may evade the scraping effect of the cleaning blade, and pass through the tiny spaces. If a relatively large amount of the toners are not removed by the cleaning blade, it will lead to lower cleanability, and result in production of unfavorable images, such as an image having background fogging.

Another drawback is a phenomenon known as filming, which may happen as follows: Toners that have evaded the scraping effect of the cleaning blade remain on the photoconductive member's surface. If the toners remain on the photoconductive member for a longer period, chemical agents, such as releasing agents or fluidity improving agents contained in toners, may adhere and produce a film on the photoconductive member's surface. When this filming phenomenon happens, abnormal images having white spots may happen on a solid area of images. To increase the cleanability of the photoconductive member when the above-mentioned highly spherical toners and smaller diameter toners are used, a method has been employed of applying a lubrication agent, such as a fatty acid metallic salt, on a photoconductive member's surface and forming a thin layer of the lubrication agent on the photoconductive member's surface to reduce the friction coefficient of the photoconductive member's surface.

A reduced friction coefficient of the photoconductive member's surface leads to a decrease in adhesiveness between toners and the photoconductive member so that the cleaning blade can effectively clean the photoconductive member, and the filming phenomenon can be suppressed.

However, if a friction coefficient of the photoconductive member's surface is significantly reduced, other drawbacks, such as image dropouts and lower-density images, may happen as below.

When the friction coefficient of the photoconductive member's surface is reduced significantly, it leads to a relatively lower adhesiveness between toners and the photoconductive member when conducting the developing process. Under such conditions, toners may not be sufficiently supplied from a developing roller to an electrostatic latent image formed on the photoconductive member, resulting in image degradation, such as image dropouts or lower-density images.

Conventionally, the friction coefficient of the photoconductive member's surface is adjusted by measuring the friction coefficient of the photoconductive member's surface using the Euler's belt method. However, when highly spherical toners and smaller diameter toners are used for image forming, a more precise analysis on the photoconductive member's surface is required to detect and reduce effects, such as filming, on the photoconductive member's surface and resultant white patch in produced images.

### SUMMARY OF THE INVENTION

Accordingly, one object of the present invention is to provide an apparatus for electrophotographic image formation that overcomes the above noted disadvantages.

A further object of the present invention is to provide a toner for use in such an apparatus that provides good image formation, while retaining high cleanability.

Another object of the present invention is to provide a lubrication agent for use in such an apparatus that preferably lowers friction between the image carrier and the cleaning blade to provide good image formation.

These and other objects of the present invention, either individually or collectively, have been satisfied by the discovery of an image forming apparatus, comprising:
an image carrier;
a cleaning mechanism having a cleaning blade configured to clean materials including a toner remaining on a surface of the image carrier; and
an application mechanism configured to apply a lubrication agent on the surface of the image carrier,
wherein the toner is free from zinc and has an average circularity of at least 0.93, the lubrication agent comprises zinc stearate, and a zinc amount on the surface of the image carrier after a cleaning process by the cleaning mechanism and an application process by the application mechanism is from 0.4 to 2.5 atm %;
a method for applying the lubrication agent in use of the apparatus, a process cartridge containing the application mechanism and toner for use in the apparatus.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic configuration of an image forming apparatus according to an exemplary embodiment of the present invention;

FIG. 2 is a schematic configuration of a photoconductive member unit of an image forming apparatus according to an exemplary embodiment of the present invention;

FIG. 3A is an exemplary schematic view for explaining a first shape factor SF-1 of a toner;

FIG. 3B is another exemplary schematic view for explaining a second shape factor SF-2 of a toner; and

FIGS. 4A, 4B, and 4C are schematic shapes of a toner according to an exemplary embodiment of the present invention.

### DETAILED DESCRIPTION OF THE PREFERRED EMBODIMENTS

In describing preferred embodiments illustrated in the drawings, specific terminology is employed for the sake of clarity. However, it is to be understood that the use of such terminology is for illustrative purposes only, and the disclosure of the present invention is not intended to be limited to the specific terminology used.

The present invention relates to an image forming apparatus comprising an image carrier, a charging unit, an exposing unit, a developing unit, a transfer unit, a cleaning mechanism, and an application mechanism. The charging unit charges the image carrier. The exposing unit exposes a surface of the image carrier to write an electrostatic latent image on the surface of the image carrier. The developing unit supplies a toner to the electrostatic latent image to make visible the electrostatic latent image. The transfer unit transfers the visible image to a recoding medium. The cleaning mechanism, preferably of a type having a cleaning blade, cleans the surface of the image carrier after transferring the visible image to the recoding medium. The application mechanism applies a lubrication agent on the surface of the image carrier after transferring the visible image to the recoding medium.

The toner used in the present invention apparatus is free from zinc and has an average circularity of at least 0.93, the lubrication agent preferably includes zinc stearate, and a zinc amount on the surface of the image carrier after the cleaning process by the cleaning mechanism and an application process by the application mechanism is preferably from 0.4 to 2.5 atm %.

In the present invention image forming apparatus, the application mechanism includes a lubrication agent block preferably formed of zinc stearate, a biasing device, and an application roller.

The application roller is preferably configured to scrape the lubrication agent from the lubrication agent block and apply the scraped lubrication agent on the surface of the image carrier. The application roller preferably includes a brush-type roller.

The biasing device preferably includes a spring, and biases the lubrication agent block to the application roller with a preferred pressure of from 200 to 3,000 mN.

The image carrier and the application roller have a circumferential speed ratio of preferably from 0.8 to 1.2, wherein the circumferential speed ratio is calculated by dividing a circumferential speed of the image carrier with a circumferential speed of the application roller.

The toner preferably includes a negatively-charged toner, which is preferably obtained by treating a surface of a mother toner particle in a solution containing a fluorinated compound. The fluorinated compound more preferably includes a surfactant having a polarity different from the surface polarity of the mother toner particle before the treatment.

The toner is preferably prepared by a method including the steps of dissolving or dispersing, and dispersing. The dissolving or dispersing step dissolves or disperses at least a polyester prepolymer having a functional group containing a nitrogen atom, polyester, a coloring agent, and a releasing agent in an organic solvent to prepare a toner constituent mixture liquid, and the dispersing step disperses the toner constituent mixture liquid in an aqueous medium while subjecting the polymer to at least one of an extension reaction and a crosslinking reaction.

The toner preferably has a volume average diameter of from 3 to 8 μm, and a ratio (Dv/Dn) of volume average diameter (Dv) and number average diameter (Dn) of the toner is preferably from 1.00 to 1.40. Further, the toner more preferably has a first shape factor of from 100 to 180, and a second shape factor of from 100 to 180. Still more preferably, the toner has a substantially spherical shape, and satisfies a relationship of 0.5≦(r2/r1)≦1.0 and 0.7≦(r3/r2)≦1.0, wherein r1, r2 and r3 represent an average major axis diameter of toner particle, an average minor axis diameter of toner particle and an average thickness of toner particle, and r1, r2 and r3 have a relationship of r3≦r2≦r1.

The present invention further includes a method of applying a lubrication agent for use in an image forming apparatus having an image carrier, a cleaning mechanism, and an application mechanism, this method comprising the steps of applying and cleaning. The applying step applies a lubrication agent on the surface of the image carrier with the application mechanism including a lubrication agent block, an application roller, and a biasing device. The cleaning step cleans a surface of the image carrier with the cleaning mechanism including a blade.

The present invention also relates to a process cartridge that is detachably provided with the image forming apparatus of the present invention.

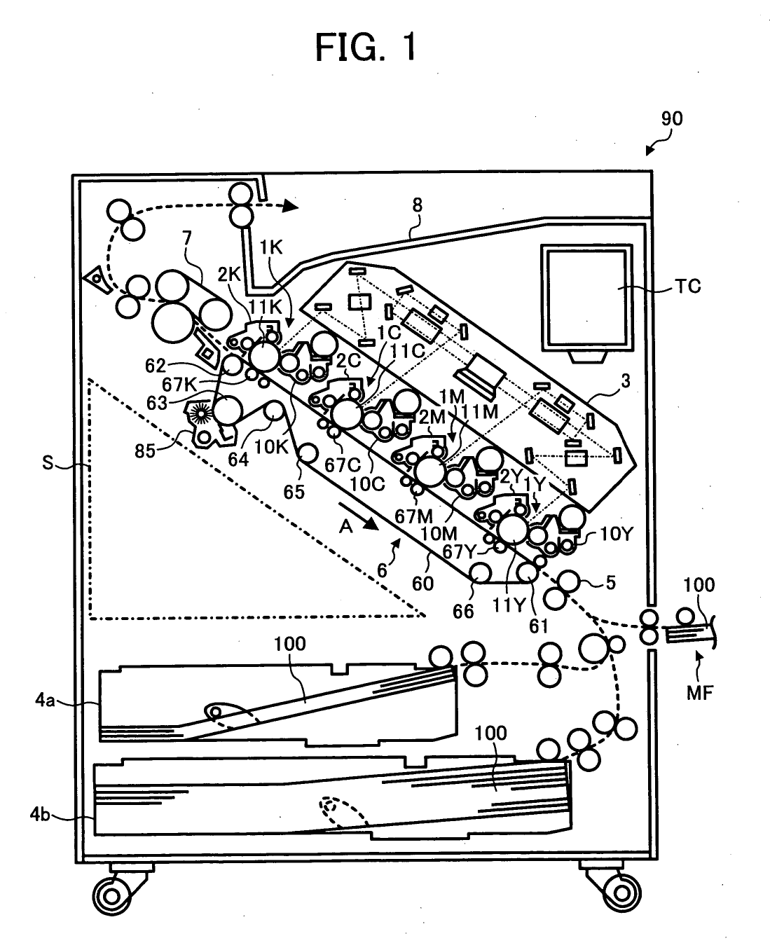

Referring now to the drawings, wherein like reference numerals designate identical or corresponding parts throughout the several views, and more particularly to FIG. 1 thereof, a configuration of an image forming apparatus according to an exemplary embodiment of the present invention is described.

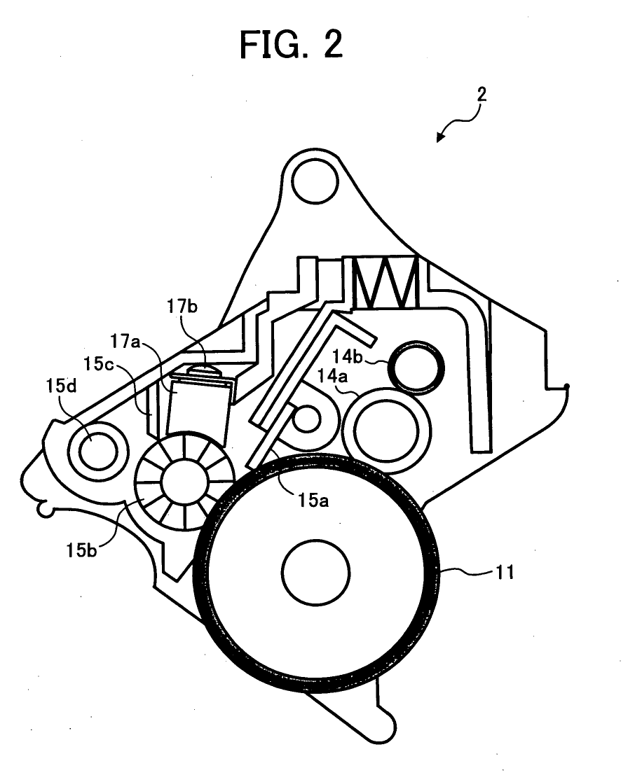

Referring to FIG. 2, a configuration of a photoconductive member unit according to an exemplary embodiment of the present invention is described.

A shown in FIG. 1, an image forming apparatus 90 in FIG. 1 includes four image forming units 1Y, 1M, 1C and 1K, an optical writing unit 3, sheet cassettes 4a and 4b, a registration roller 5, a transport unit 6, a fusing unit 7, a sheet ejection tray 8, and a belt cleaning unit 85.

Each of the image forming units 1Y, 1M, 1C and 1K includes photoconductive drums 11Y, 11M, 11C, and 11K (i.e., image carrier), developing units 10Y, 10M, 10C, and 10K, photoconductive member units 2Y, 2M, 2C, and 2K respectively, and a cleaning mechanism (to be described later).

Each of the image forming units 1Y, 1M, 1C and 1K forms each color image of yellow (Y), magenta (M), cyan (C), and black (K), respectively. The arrangement of the image forming units 1Y, 1M, 1C and 1K in the image forming apparatus 90 is not limited to a Y/M/C/K sequential arrangement shown in FIG. 1, but any desired arrangement can be employed, as required.

The image forming units 1Y, 1M, 1C and 1K are arranged with a predetermined pitch distance along a traveling direction of transfer sheets, and the shafts of the photoconductive drums 11Y, 11M, 11C, and 11K are arranged relative to each other in a parallel manner.

On the above side of the image forming units 1Y, 1M, 1C and 1K, the optical writing unit 3 is provided, having a light source, a polygon mirror, an f-theta lens, and a plurality of reflecting mirrors.

The optical writing unit 3 scans laser beams on surfaces of the each of photoconductive drums 11Y, 11M, 11C, and 11K based on image data input to the image forming apparatus 90.

On the lower side of the image forming units 1Y, 1M, 1C and 1K, the transport unit 6 is provided.

The transport unit 6 includes a transport belt 60, rollers 61 to 66 for transporting a transfer sheet to an image transferring area of each of the image forming units 1Y, 1M, 1C, and 1K, and transfer rollers 67Y, 67M, 67C, and 67K. As shown in FIG. 1, the transport belt 60 travels in arrow direction “A.”

The belt cleaning unit 85 having brush roller and a cleaning blade contacts an outer surface of the transport belt 60. The belt cleaning unit 85 removes foreign materials such as toner adhered on the transport belt 60.

The fusing unit 7 employing a belt fusing method is provided to an end side of the transport unit 6 as shown in FIG. 1.

The sheet cassettes 4a and 4b, provided in a lower part of the image forming apparatus 90, store stacks of transfer sheets 100 therein.

The image forming apparatus 90 also includes a manual feed tray MF configured to manually-feed transfer sheets 100 from an outer side of the image forming apparatus 90 as shown in FIG. 1.

The image forming apparatus 90 also includes a toner cartridge TC, a discharged toner bottle (not shown), a double-face copy unit and sheet-inverting unit (not shown), and a power unit (not shown) in a space “S” indicated by an alternate long and short dash line in FIG. 1.

Each of the developing units 10Y, 10M, 10C, and 10K has a similar configuration to one another except using a respective different color toner. In the image forming apparatus 90, the developing units 10Y, 10M, 10C, and 10K employ a two-component developer including toners and magnetic carriers, for example. Each of the developing units 10Y, 10M, 10C, and 10K includes a developing roller facing the photoconductive drums 11Y, 11M, 11C, and 11K, a screw (not shown) for transporting and agitating the developing agent, and a toner concentration sensor (not shown). The developing roller includes a rotatable outer sleeve (not shown) and an inner-fixed magnet (not shown). The toner cartridge TC supplies toners to the developing units 10Y, 10M, 10C, and 10K according to an output signal from the toner concentration sensor. Hereinafter, for simplifying the expression in this specification, the developing units 10Y, 10M, 10C, and 10K are collectively expressed as the developing unit 10, as required.

Each of the photoconductive member units 2Y, 2M, 2C, and 2K has a similar configuration to one another. As illustrated in FIG. 2, each of the photoconductive member units 2Y, 2M, 2C, and 2K includes the photoconductive drums 11Y, 11M, 11C, and 11K, respectively, a charging unit 14, a cleaning blade 15a, a cleaning brush 15b shaped like a bar extending to a longitudinal direction of the photoconductive drum 11, a scraper 15c, and a toner transport auger 15d, a lubrication agent block 17a, and a biasing spring 17b. For simplifying the expression in this specification, the photoconductive drums 11Y, 11M, 11C, and 11K is collectively expressed as the photoconductive drum 11, as required.

The charging unit 14 includes a charging roller 14a and a charge cleaning roller 14b. The charging roller 14a includes an electro-conductive core metal, an elastic layer as charged member having a medium resistance value, wherein the elastic layer is put on the electro-conductive core metal. The charging roller 14a is connected to a power source (not shown) and is supplied with a predetermined voltage. The charge cleaning roller 14b includes a cylindrical core metal and a resinous foaming agent, wherein the resinous foaming agent is wound around the cylindrical core metal, for example.

The charging roller 14a may contact the photoconductive drum 11, or may have a relatively small gap (not shown) with the photoconductive drum 11.

The relatively small gap (not shown) can be provided by putting a ring-shaped spacer having a certain thickness to both end portion of the charging roller 14a, wherein the end portion of the charging roller 14a is not used for image forming, and contacting the ring-shaped spacer to the surface of the photoconductive drum 11, for example.

As shown in FIG. 2, the charging roller 14a and the charge cleaning roller 14b contact with each other, and the charging roller 14a and the photoconductive drum 11 contact with each other.

The photoconductive drum 11 is cleaned by the cleaning mechanism including the above-mentioned cleaning blade 15a, cleaning brush 15b, scraper 15c, and toner transport auger 15d. After transferring toner image to the transfer sheet, the cleaning blade 15a scrapes toners remaining on the surface of the photoconductive drum 11. The scraped toners are collected by the cleaning brush 15b. The scraper 15c contacts the cleaning brush 15b to remove toners adhered on brush fibers of the cleaning brush 15b. Then, toners are moved from the cleaning brush 15b to the toner transport auger 15d. The toner transport auger 15d rotates to transport and recover disposed toners in a disposed-toner container (not shown).

In the image forming apparatus 90, a lubrication agent is applied by a lubrication mechanism including the above-mentioned lubrication agent block 17a, the biasing spring 17b, and the cleaning brush 15b. The lubrication agent block 17a is preferably prepared by forming zinc stearate in a block shape in the present invention.

The cleaning brush 15b, used to clean the photoconductive drum 11 as above-described, is also used for applying the lubrication agent on the surface of the photoconductive drum 11 as described below.

As shown in FIG. 2, the cleaning brush 15b contacts the lubrication agent block 17a to chip away the lubrication agent and supply the chipped lubrication agent uniformly on the surface of the photoconductive drum 11. The biasing spring 17b biases the lubrication agent block 17a to the cleaning brush 15b with a predetermined pressure so that the lubrication agent block 17a can be moved toward the cleaning brush 15b after each chipping, and to minimize amount of unused lubrication agent after a final chipping of the lubrication agent block 17a by the cleaning brush 15b. The biasing spring 17b continuously biases the chipped lubrication agent block 17a to the cleaning brush 15b so that the lubrication agent block 17a can be continuously chipped away by the cleaning brush 15b, and can be continuously supplied to the photoconductive drum 11.

The lubrication mechanism may employ other configurations in addition to the above-described configuration. For example, the lubrication agent block 17a can be contacted to the surface of the photoconductive drum 11 directly, or a powder type lubrication agent can be supplied to the surface of the photoconductive drum 11. However, above-described configuration having the lubrication agent block 17a and the cleaning brush 15b is preferable when considering an effective adjustment of the application amount of the lubrication agent to the surface of the photoconductive drum 11.

The above-described image forming apparatus 90 conducts an image forming process as below.

The power source (not shown) supplies a predetermined voltage to the charging roller 14a. The charging roller 14a charges the surface of the photoconductive drum 11 to a predetermined voltage level. Based on image data input to the image forming apparatus 90, the optical writing unit 3 scans the charged surface of the photoconductive drum 11 with a laser beam to form an electrostatic latent image on the surface of the photoconductive drum 11. When the photoconductive drum 11, having the electrostatic latent image thereon, comes to a position facing the developing unit 10, the developing roller facing the photoconductive drum 11 supplies toners to the electrostatic latent image on the photoconductive drum 11 to form a toner image on the photoconductive drum 11.

By conducting the above-described processes with a predetermined timing, a predetermined respective color toner image is formed on the respective surfaces of the photoconductive drums 11Y, 11M, 11C, and 11K.

As shown in FIG. 1, the transfer sheet 100 can be fed from the sheet cassettes 4a and 4b or the manual feed tray MF. When the transfer sheet 100 is transported to the registration roller 5, the transportation of the transfer sheet 100 is suspended temporarily.

The registration roller 5 feeds the transfer sheet 100 to the photoconductive member units 2Y, 2M, 2C, and 2K by synchronizing a transfer sheet feed timing with the above-described image forming processes. The transfer sheet 100 is transported on the transport belt 60, and sequentially receives each toner image from the photoconductive drums 11Y, 11M, 11C, and 11K. The toner images are transferred to the transfer sheet 100 by using the transfer rollers 67Y, 67M, 67C, and 67K. The transfer rollers 67Y, 67M, 67C, and 67K face the photoconductive drums 11Y, 11M, 11C, and 11K, respectively, by sandwiching the transport belt 60 between the primary transfer rollers and the photoconductive drums.

A power source (not shown) applies a voltage level having one polarity to the transfer rollers 67Y, 67M, 67C, and 67K to conduct the toner images transferring to the transfer sheet 100, wherein such polarity is different from the polarity applied to the photoconductive drums 11Y, 11M, 11C, and 11K.

The transfer sheet 100 receives four superimposed toner images through the above-described processes. The transfer sheet 100 having the toner images is then transported to the fusing unit 7. The fusing unit 7 fixes the toner images on the transfer sheet 100 by applying heat and pressure to the transfer sheet 100. After transferring the toner image to the transfer sheet 100, the surface of the photoconductive drum 11 comes to a position for a cleaning process and a lubrication agent application process.

To prepare the photoconductive drum 11 for a next image forming process, the cleaning brush 15b applies the lubrication agent (i.e., zinc stearate) to the surface of the photoconductive drum 11, and the cleaning blade 15a scrapes toners remaining on the surface of the photoconductive drum 11. During the above-mentioned processes, the zinc stearate applied to the surface of the photoconductive drum 11 receives a scraping operation of the cleaning blade 15a, so that the zinc stearate can be uniformly extended over the surface of the photoconductive drum 11, and a thin layer of zinc stearate can be formed uniformly on the surface of the photoconductive drum 11.

With the formation of the thin layer of zinc stearate on the surface of the photoconductive drum 11, the friction coefficient of the surface of the photoconductive drum 11 can be reduced. Consequently, transferability of the developed toner images and cleanability of remaining toners on the photoconductive drum 11 can be improved.

The image forming apparatus 90 employs toners having an average circularity of 0.93 for the developing unit 10 to produce high quality and highly precise images on the transfer sheet 100. As expressed in a below formula, the circularity of toner particle is defined as the ratio between the circumference of a circle having equivalent area (defined as “equivalent circle circumference”) to the toner particle and the perimeter of the toner particle (defined as “particle perimeter”),
Circularity=(Equivalent circle circumference)/(Particle perimeter),
wherein the toner particle is optically projected to a plane for measurement of the circularity.

The more spherical the particle, the closer its circularity is to 1.00. The more elongated the particle, the lower its circularity. In particular, the average circularity of toner may be measured using a flow particle image analyzer FPIA-2100 manufactured by SYSMEX Co., Ltd.

Each sample is prepared as below for measurement of the circularity of toner. At first, purified water of 100 to 150 ml is poured in a vessel. Then, 0.1 to 0.5 ml of surfactant is added to the water as dispersing agent. And then, a sample of 0.1 to 9.5 g is added to the solution. The mixed solution is dispersed for one to three minutes by an ultrasonic dispersion apparatus. After adjusting concentration of the dispersed solution to a level of 3,000 to 10,000 particles per μl, toner shape distribution is measured.

As mentioned above, the image forming apparatus 90 employs toners having a larger (i.e. closer to 1.00) average circularity. Therefore, the image forming apparatus 90 has a relatively stringent condition for cleanability of the toners. Accordingly, a consideration is given to form a thin layer of zinc stearate having a preferable thickness on the surface of the photoconductive drum 11.

As for the image forming apparatus 90, the zinc amount on the surface of the photoconductive drum 11 after the cleaning process and the zinc stearate application process is adjusted to 0.4 to 2.5 atm %.

The zinc amount on the surface of the photoconductive drum 11 after receiving the zinc stearate application process can be measured by analyzing the surface of the photoconductive drum 11 with a XPS (X-ray photoelectron spectroscopy) method. The depth that can be detected by the XPS is several nanometers from the top surface of a material. Accordingly, the amount of zinc on the top surface of the photoconductive drum 11 can be measured.

As for the image forming apparatus 90, the toners used in the developing unit 10 are free a measurable amount of zinc (referred herein as “free of zinc”).

Therefore, the zinc amount on the surface of the photoconductive drum 11 is equal to the zinc amount contained in the zinc stearate in the lubrication agent.

If the zinc amount is too small, a thin layer of zinc stearate cannot be formed uniformly on the surface of the photoconductive drum 11. In this case, friction reduction between the cleaning blade 15a and the photoconductive drum 11K is not effectively obtained. If toner having a higher circularity is used in such condition, toners may evade cleaning effect of the cleaning blade 15a. Consequently, defective cleaning may happen on the surface of the photoconductive drum 11, and resulting in filming on the surface of the photoconductive drum 11.

If the zinc amount is within a range of 0.4 to 2.5 atm %, a thin layer of zinc stearate can be formed uniformly on the surface of the photoconductive drum 11 so that the cleanability on the surface of the photoconductive drum 11 can be improved, and the filming phenomenon can be suppressed significantly. If the zinc amount is too large, further improvement of the cleanability and the filming phenomenon may not be observed. On the contrary, toners may not be sufficiently transferred from the developing roller to the electrostatic latent image on the photoconductive drum 11 during the developing process, resulting in an unfavorable condition.

To maintain the zinc amount on the surface of the photoconductive drum 11 within the above-mentioned range of 0.4 to 2.5 atm %, the lubrication agent is preferably applied as below.

The lubrication agent block 17a is preferably biased toward the cleaning brush 15b by the biasing spring 17b. Such biasing pressure is preferably 200 mN or more including the weight of the lubrication agent block 17a. The larger the biasing pressure, the larger the chipping amount of lubrication agent of lubrication agent block 17a by the cleaning brush 15b. The larger the chipping amount of the lubrication agent, the larger the application amount of the lubrication agent to the surface of the photoconductive drum 11. If the above-described biasing pressure becomes too large, more than the necessary amount of lubrication agent is supplied to the surface of the photoconductive drum 11. In such a case, the friction coefficient of the photoconductive drum 11 may take a value which is lower than desired or necessary, resulting in contamination of the surface of the charging roller 14a by a large amount of the lubrication agent, and breakup of the lubrication agent block 17a.

Therefore, the above-described biasing pressure is preferably set within a range of 200 to 3,000 mN.

The cleaning brush 15b and the photoconductive drum 11 rotate in directions that are counter to each other so that the rotating direction of the cleaning brush 15b and the rotating direction of the photoconductive drum 11 become the same direction at a contact point between the cleaning brush 15b and the photoconductive drum 11.

By using a brush type roller (i.e., cleaning brush 15b) in such an arrangement, the lubrication agent can be supplied to the surface of the photoconductive drum 11 from brushes of the cleaning brush 15b without causing damage on the surface of the photoconductive drum 11.

A circumferential speed ratio of the photoconductive drum 11 and the cleaning brush 15b is preferably set within a range of 0.8 to 1.2, wherein the circumferential speed ratio is calculated by dividing the circumferential speed of the photoconductive drum 11 by the circumferential speed of the cleaning brush 15b. If the circumferential speed ratio is too small, the lubrication agent is not sufficiently supplied to the photoconductive drum 11. If the circumferential speed ratio is too large, the surface of the photoconductive drums 11 may be damaged by an impact with the cleaning brush 15b, and resulting into a shorter lifetime of the photoconductive drum 11.

Accordingly, the circumferential speed ratio is more preferably set within a range of 1.0 to 1.1.

Hereinafter, toners used in image forming apparatus 90 are explained in detail.

As above mentioned, toners used in the present invention have an average circularity of 0.93 or more, which indicates a higher circularity of the toners. Such higher circularity toner can be prepared from monomers and an organic solvent dissolved in an aqueous medium using a emulsifying method, a suspension method, or an aggregation method.

The toners used in the present invention, free from zinc, have a negative polarity and preferably include a fluorinated compound. Therefore, the determination of the zinc amount applied on the surface of the photoconductive drum 11 is not affected by such toners.

Hereinafter, materials and a production process for such toners are explained.

Suspension Polymerization Method

The suspension polymerization method is summarized as below.

Toner constituents such as a colorant, a release agent and optional additives are dispersed in a mixture of one or more monomers and an oil-soluble initiator. The mixture is emulsified in an aqueous medium including a surfactant, a solid dispersant, etc. using one of the below-mentioned emulsifying methods. Then, the emulsion is subjected to a polymerization reaction to prepare polymer particles (i.e., a particulate organic material) including the colorant, release agent and other optional additives.

Then, a surface treatment to be described later is conducted on the prepared particles (i.e., toner constituent particles).

Emulsion Polymerization/Aggregation Method

The emulsion polymerization/aggregation method is summarized as below.

A water-soluble initiator and one or more monomers are emulsified in water including a surfactant using a known emulsion polymerization method. An aqueous dispersion in which toner constituents such as a colorant, a release agent and optional additives are dispersed in water is added to the emulsion prepared above. Then the particles of the mixture are aggregated, followed by heat treatment to fuse the aggregated particles to form toner constituent particles.

Then, a surface treatment to be described later is conducted on the prepared particles (i.e., toner constituent particles).

Polymer Suspension Method

The polymer suspension method is summarized as below.

As for the polymer suspension method, water alone or a water-solution including a water-soluble solvent can be used as the aqueous medium. As for the water-soluble solvent, alcohols (e.g., methanol, isopropanol, ethylene glycol), dimethylformamide, tetrahydrofuran, cellosolve (e.g., methyl cellosolve), and lower ketones (e.g., acetone, methyl ethyl ketone) ares exemplified.

Toner constituents such as a resin, a prepolymer, a colorant (such as pigments), and additives, such as a release agent and a charge controlling agent, are dissolved or dispersed in a volatile organic solvent to prepare a toner constituent mixture liquid (i.e., an oil phase liquid).

The toner constituent mixture liquid (i.e., an oil phase liquid) is mixed with a surfactant or a dispersing agent in the aqueous medium to perform a prepolymer reaction to obtain particles (i.e., toner constituent particles).

Then, a surface treatment to be described later is conducted on the prepared particles (i.e., toner constituent particles).

Surface Treatment Method

The surface treatment method for the toner is summarized as below.

The toner constituent particles prepared by any of the above-mentioned methods can be treated to impart a charge control property to toner constituent particles. It is preferable to perform this treatment after the toner constituent particles are washed to remove foreign materials such as free surfactants. Specifically, excessive surfactants present in a dispersion including the toner constituent particles are separated by subjecting the dispersion to filtering or centrifugal separation. Then the cake or slurry thus obtained is dispersed again in an aqueous medium. Then a surfactant solution with a polarity different from that of the toner constituent particles is added thereto while agitating the aqueous medium.

The added amount of the surfactant solution is such that the weight ratio of the surfactant to the toner constituent particles is from 0.01/100 to 1/100.

The polarity of the surface of the toner particles is affected by several factors such as the to-be-used surfactant and the resultant polymer.

As above described, an aqueous medium having a surfactant is used for the toner particle forming process. Because the surfactant has a relatively higher affinity with monomers and organic solvents, the surfactant is likely to remain on the surface of toner particles. Thus, the polarity of the surfactant affects the polarity of the surface of toner particles.

As for the polymer suspension method, resins having a lower molecular weight are used to lower the viscosity in a dispersing solution so that an emulsification process can be conducted easily. After the emulsification process, the resins having a lower molecular weight are subjected to an extension and/or crosslinking reaction to obtain particles having a high molecular weight resin. The polarity of the polymer obtained by the extension and/or crosslinking reaction becomes the polarity of the surface of toner particles.

When such a material having a polarity exists on the surface of the toner particles, it may destabilize a charge property of the toner particles. However, such effect on the toner charge property can be minimized by treating the surface of the toner particles with a surfactant having a polarity that is different from the polarity that exists on the surface of the toner particles.

By using a fluorine-containing surfactant as the surfactant having a different polarity, good charging properties and good charge rising property can be imparted to the resultant toner particles.

Specific preferred examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium 3-{omega-fluoroalkanoyl(C6-C8)-N-ethylamino}-1-propanesulfonate, fluoroalkyl(C11-C20) carboxylic acids and their metal salts, perfluoroalkyl(C7-C13) carboxylic acids and their metal salts, perfluoroalkyl(C4-C12) sulfonate and their metal salts, perfluorooctanesulfonic acid diethanol amides, N-propyl-N-(2-hydroxyethyl)perfluorooctanesulfone amide, perfluoroalkyl(C6-C10) sulfoneamidepropyltrimethylammonium salts, salts of perfluoroalkyl(C6-C10)-N-ethylsulfonyl glycin, monoperfluoroalkyl(C6-C16) ethylphosphates ester, etc.

Specific preferred examples of commercially available surfactants include SARFRON® S-111, S-112 and S-113, which are manufactured by Asahi Glass Co., Ltd.; FLUORAD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-10, F-120, F-113, F-191, F-812 and F-833, which are manufactured by Dainippon Ink and Chemicals, Inc.; ECTOP® EF-102, 103, 104, 105, 112, 123A, 123B, 306A, 501, 201 and 204, which are manufactured by Tohchem Products Co., Ltd.; FUTARGENT® F-100 and F150 manufactured by Neos; etc.

Specific preferred examples of the cationic surfactants having a fluoroalkyl group include primary, secondary and tertiary aliphatic amines having a fluoroalkyl group, aliphatic quaternary ammonium salts such as perfluoroalkyl(C6-C10) sulfoneamidepropyltrimethylammonium salts, benzalkonium salts, benzetonium chloride, pyridinium salts, imidazolinium salts, etc.

Specific preferred examples of commercially available cationic surfactants of this type include SARFRON® S-121 (from Asahi Glass Co., Ltd.); FLUORAD® FC-135 (from Sumitomo 3M Ltd.); UNIDYNE® DS-202 (from Daikin Industries, Ltd.); MEGAFACE® F-150 and F-824 (from Dainippon Ink and Chemicals, Inc.); ECTOP® EF-132 (from Tohchem Products Co., Ltd.); FUTARGENT® F-300 (from Neos); etc.

In particular, when fluorine-containing quaternary ammonium salts having the below-mentioned formula (1) are used, the resultant toner has good charge stability even when environmental conditions are changed. 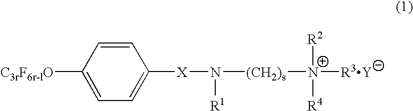
wherein X represents —SO₂—, or —CO—; Y represents I or Br; R¹, R², R³ and R⁴ each, independently, represent a hydrogen atom, an alkyl group having 1 to 10 carbon atoms or an aryl group; and each of r and s is independently an integer of from 1 to 20.

To reinforce the charge property, resin particles can be dispersed in slurry.

By adding a surfactant having a different polarity, charges of resin particles dispersed in an aqueous medium are neutralized so that the resin particles can be accumulated on the surface of the toner particles.

The weight ratio of the resin particles to the toner particles is preferably from 0.01/100 to 5/100.

Fine Resin Particle Having Charge Controllable Property

As for the fine resin particle having charge controllable property, known resin particles can be used.

For example, fine polymer particles obtained by a soap-free emulsion polymerization method, a suspension polymerization method, or a dispersion polymerization method are preferable for the fine resin particles having charge controllable property.

More preferably, polystyrene copolymerized with a monomer such as methacrylic acid containing a carboxyl group, a polymer copolymerized fluorinated methacrylic acid ester or fluorinated acrylic ester by emulsion polymerization method and/or dispersion polymerization method, a polymer polycondensed silicone, benzoguanamine, nylon, etc., and a polymer formed by thermosetting resin is exemplified.

Such charge control agent particles or resin particles, which adhere on the toner surface, can be fixed and retained on the toner surface by heating the slurry. Such heating is preferably conducted at a temperature, which is higher than the Tg (glass transition temperature) of the resin included in the toner. The heating may be conducted after conducting a drying process.

Mother toner particles for the toner used in the present invention can be prepared from materials and production processes described hereinafter.

Modified Polyester

The toner used in the present invention preferably includes a modified polyester (i) as binder resin, which is described as below.

The modified polyester (i) includes a bonding group other than the ester bonding in a polyester resin, or a different resin bonded in a polyester resin with covalent bonding or ion bonding.

Specifically, the modified polyester (i) includes a polyester modified at its end portion. For example, a functional group such as isocyanate group is added to the end portion of a polyester, and the functional group is reacted with a carboxylic acid group or hydroxyl group, and further reacted with a compound having an active hydrogen atom to obtain a modified polyester.

The modified polyester (i) can further include an urea-modified polyester obtained by reacting a polyester prepolymer (A) having a polyisocyanate group and amines (B). As the polyester prepolymer (A) having a polyisocyanate group, for example, compounds prepared by reacting a polycondensation product of a polyol (PO) and a polycarboxylic acid (PC) including a group having a hydrogen reactive with a polyisocyanate (PIC) are used.

Suitable groups having an active hydrogen include, but are not limited to, a hydroxyl group (an alcoholic hydroxyl group or a phenolic hydroxyl group), an amino group, a carboxyl group, a mercapto group, etc. Among these groups, alcoholic hydroxyl groups are preferable.

A prepolymer is preferably used for preparing toner constituent particles using the polymer suspension method. A prepolymer serves as a binder resin of the resultant toner while being further polymerized during the toner particle preparation process.

The urea-modified polyester is prepared with a method described hereinafter.

Suitable polyols (PO) include, but are not limited to, diols (DIO) and polyols (TO) having three or more hydroxyl groups. Preferably, diols (DIO) or mixtures in which a small amount of a polyol (TO) is added to a diol (DO) are used.

Specific preferred examples of the diols (DIO) include alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F and bisphenol S); adducts of the alicyclic diols mentioned above with an alkylene oxide (e.g., ethylene oxide, propylene oxide and butylene oxide); adducts of the bisphenols mentioned above with an alkylene oxide (e.g., ethylene oxide, propylene oxide and butylene oxide); etc.

Among these compounds, alkylene glycols having from 2 to 12 carbon atoms and adducts of bisphenols with an alkylene oxide are preferable. More preferably, adducts of bisphenols with an alkylene oxide, or mixtures of an adduct of bisphenols with an alkylene oxide and an alkylene glycol having from 2 to 12 carbon atoms are used.

Specific preferred examples of the polyols (TO) include aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide; etc.

Suitable polycarboxylic acids (PC) include, but are not limited to, dicarboxylic acids (DIC) and polycarboxylic acids (TC) having three or more carboxyl groups. Preferably, dicarboxylic acids (DIC) or mixtures in which a small amount of a polycarboxylic acid (TC) is added to a dicarboxylic acid (DIC) are used.

Specific preferred examples of the dicarboxylic acids (DIC) include alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids) etc. Among these compounds, alkenylene dicarboxylic acids having from 4 to 20 carbon atoms and aromatic dicarboxylic acids having from 8 to 20 carbon atoms are preferably used.

Specific preferred examples of the polycarboxylic acids (TC) having three or more hydroxyl groups include aromatic polycarboxylic acids having from 9 to 20 carbon atoms (e.g., trimellitic acid and pyromellitic acid).

As the polycarboxylic acid (PC), anhydrides or lower alkyl esters (e.g., methyl esters, ethyl esters or isopropyl esters) of the polycarboxylic acids mentioned above can be used for the reaction with a polyol (PO).

A suitable mixing ratio (i.e., an equivalence ratio [OH]/[COOH]) of (the [OH] of) a polyol (PO) to (the [COOH] of) a polycarboxylic acid (PC) is generally from 2/1 to 1/1, preferably from 1.5/1 to 1/1, and more preferably from 1.3/1 to 1.02/1.

Specific preferred examples of the polyisocyanates (PIC) include aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic diisocyanates (e.g., tolylene diisocyanate and diphenylmethane diisocyanate); aromatic aliphatic diisocyanates (e.g., α, α, α′, α′-tetramethyl xylylene diisocyanate); isocyanates; blocked polyisocyanates in which the polyisocyanates mentioned above are blocked with phenol derivatives, oximes or caprolactams; etc. These compounds can be used alone or in combination.

A suitable mixing ratio (i.e., [NCO]/[OH]) of (the [NCO] of) a polyisocyanate (PIC) to (the [OH] of) a polyester is generally from 5/1 to 1/1, preferably from 4/1 to 1.2/1, and more preferably from 2.5/1 to 1.5/1. When the [NCO]/[OH] ratio is too large, the low temperature fixability of the toner deteriorates. In contrast, when the ratio is too small, the content of the urea group in the modified polyesters decreases and thereby the hot-offset resistance of the toner deteriorates.

The content of the constitutional component of a polyisocyanate (PIC) in the polyester prepolymer (A) having a polyisocyanate group at its end portion is generally from 0.5 to 40% by weight, preferably from 1 to 30% by weight, and more preferably from 2 to 20% by weight. When the content is too low, the hot offset resistance of the toner deteriorates and in addition the heat resistance and low temperature fixability of the toner also deteriorate. In contrast, when the content is too high, the low temperature fixability of the toner deteriorates.

The number of the isocyanate group included in a molecule of the polyester prepolymer (A) is generally not less than 1, preferably from 1.5 to 3, and more preferably from 1.8 to 2.5. When the number of the isocyanate group is too small, the molecular weight of the resultant urea-modified polyester decreases and thereby the hot offset resistance deteriorate.

Specific preferred examples of the amines (B), to be reacted with the polyester prepolymer (A), include diamines (B1), polyamines (B2) having three or more amino groups, amino alcohols (B3), amino mercaptans (B4), amino acids (B5) and blocked amines (B6) in which the amines (B1-B5) mentioned above are blocked.

Specific preferred examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc.

Specific preferred examples of the polyamines (B2) having three or more amino groups include diethylene triamine and triethylene tetramine; etc.

Specific preferred examples of the amino alcohols (B3) include ethanol amine and hydroxyethyl aniline; etc.

Specific preferred examples of the amino mercaptan (B4) include aminoethyl mercaptan and aminopropyl mercaptan; etc.

Specific preferred examples of the amino acids (B5) include amino propionic acid and amino caproic acid; etc.

Specific preferred examples of the blocked amines (B6) include ketimine compounds, which are prepared by reacting one of the amines B1-B5 mentioned above with a ketone such as acetone, methyl ethyl ketone and methyl isobutyl ketone; oxazoline compounds; etc.

Among these compounds, diamines (B1) and mixtures in which a diamine (B1) is mixed with a small amount of a polyamine (B2) are preferably used.

The mixing ratio (i.e., a ratio [NCO]/[NHx]) of (the [NCO] of) the polyester prepolymer (A) having an isocyanate group to (the [NHx] of) the amine (B) is generally from 1/2 to 2/1, preferably from 1.5/1 to 1/1.5, and more preferably from 1.2/1 to 1/1.2. When the mixing ratio is too low or too high, the molecular weight of the resultant urea-modified polyester decreases, resulting in deterioration of the hot offset resistance of the resultant toner.

The urea-modified polyesters may include a urethane bonding as well as a urea bonding. The molar ratio (urea/urethane) of the urea bonding to the urethane bonding is generally from 100/0 to 10/90, preferably from 80/20 to 20/80, and more preferably from 60/40 to 30/70. When the content of the urea bonding is too low, the hot offset resistance of the resultant toner deteriorates.

The modified polyester (i) used in the present invention is preferably prepared by a one shot method, or a prepolymer method, for example.

The average molecular weight of the modified polyester (i) is generally 10,000 or more, preferably from 20,000 to 10,000,000, and more preferably from 30,000 to 1,000,000. The peak molecular weight of the modified polyester (i) is preferably from 1,000 to 10,000. When the molecular weight of the modified polyester (i) is too small, an extension reaction is less likely to proceed and elasticity of the toner decreases and thereby the hot-offset resistance of the toner deteriorates. When the molecular weight of the modified polyester (i) is too large, the fixability of the toner deteriorates and the manufacturing process of the toner such as particle formation and pulverization may become complex.

When the modified polyester (i) is used alone, the number average molecular weight of the modified polyester (i) is generally 20,000 or less, preferably from 1,000 to 10,000, and more preferably from 2,000 to 8,000. When the number average molecular weight is too large, the low temperature fixability and glossiness of full-color print image may deteriorate.

As for the extension and/or crosslinking reaction of the polyester prepolymer (A) and the amines (B) for obtaining the modified polyester (i), an extension inhibitor may be used, as required. The molecular weight of the resultant urea-modified polyesters can be controlled using the extension inhibitor, if desired.

Specific preferred examples of the extension inhibitor include monoamines (e.g., diethyl amine, dibutyl amine, butyl amine and lauryl amine), and blocked amines (i.e., ketimine compounds) prepared by blocking the monoamines mentioned above.

Unmodified Polyester Resin (UMPE)

The unmodified polyester resin that can be used in the present invention is described as below.

It is preferable to use a combination of a urea-modified polyester (i) resin with an unmodified polyester resin (UMPE) (ii) as the binder resin of the toner used in the present invention in addition to using the urea-modified polyester (i) alone. By using such a combination, the low temperature fixability of the toner can be improved and, in addition, the toner can produce color images having a high glossiness.

Suitable materials for use as the UMPE (ii) resins include, but are not limited to, polycondensation products of a polyol (PO) with a polycarboxylic acid (PC). Specific preferred examples of suitable polyols (PO) and polycarboxylic acids (PC) for preparing the UMPE (ii) are similar to those mentioned above for the modified polyester (i) resins.

In addition, polyester resins modified by a bonding (such as urethane bonding) other than a urea bonding are also considered as the unmodified polyester resin (ii) in the present invention.

When a combination of a modified polyester (i) resin with an unmodified polyester resin (ii) is used as the binder resin, it is preferable that the modified polyester (i) resin is at least partially mixed with the unmodified polyester (ii) resin to improve the low temperature fixability and hot offset resistance of the toner. Namely, it is preferable that the modified polyester resin has a molecular structure similar to that of the unmodified polyester resin.

The mixing ratio (MPE/UMPE) of a modified polyester resin (MPE) to an unmodified polyester resin (UMPE) is generally from 5/95 to 80/20, preferably from 5/95 to 30/70, more preferably from 5/95 to 25/75, and even more preferably from 7/93 to 20/80. When the added amount of the modified polyester (i) resin is too small, the hot offset resistance of the toner deteriorates, and in addition, it is not preferable to achieve a good combination of high-temperature preservability and low temperature fixability.

The peak molecular weight of the unmodified polyester resins (UMPE) (ii) is generally from 1,000 to 10,000, preferably from 2,000 to 8,000 and more preferably from 2,000 to 5,000. When the peak molecular weight is too low, the high-temperature preservability of the toner deteriorates. In contrast, when the peak molecular weight is too high, the low temperature fixability of the toner deteriorates.

The unmodified polyester resin (UMPE) (ii) preferably has a hydroxyl value not less than 5 mgKOH/g, and more preferably from 10 to 120 mgKOH/g, and even more preferably from 20 to 80 mgKOH/g. When the hydroxyl value is too small, the resultant toner has poor preservability and poor low temperature fixability.

The unmodified polyester resin (UMPE) (ii) preferably has an acid value of from 1 to 5 mgKOH/g, and more preferably from 2 to 4 mgKOH/g. Since high acid value wax is used, and low acid value binder is linked to electrification and high volume resistance, such unmodified polyester (ii) is suitable for toner used as a binary developer.

The binder resin for use in the toner of the present invention preferably has a glass transition temperature (Tg) of from 35 to 70° C., and more preferably from 55 to 65° C. When the glass transition temperature is too low, the preservability of the toner deteriorates. In contrast, when the glass transition temperature is too high, the low temperature fixability deteriorates.

Even if the glass transition temperature of the toner of the present invention is low, the toner including an urea-modified polyester resin has relatively good preservability against heat compared to conventional toners including a known polyester resin as a binder resin, because the urea-modified polyester resin is likely to exist on a surface of the mother toner particle.

Colorant

The toner of the present invention includes a colorant, which is described as below.

Suitable materials for use as the colorant include known dyes and pigments.

Specific examples of the dyes and pigments include carbon black, Nigrosine dyes, black iron oxide, Naphthol Yellow S(C.I. 10316), Hansa Yellow 10G (C.I. 11710), Hansa Yellow 5G (C.I. 11660), Hansa Yellow G (C.I. 11680), Cadmium Yellow, yellow iron oxide, loess, chrome yellow, Titan Yellow, polyazo yellow, Oil Yellow, Hansa Yellow GR (C.I. 11730), Hansa Yellow A (C.I. 11735), Hansa Yellow RN(C.I. 11740), Hansa Yellow R(C.I. 12710), Pigment Yellow L (C.I. 12720), Benzidine Yellow G (C.I. 21095), Benzidine Yellow GR (C.I. 21100), Permanent Yellow NCG (C.I. 20040), Vulcan Fast Yellow 5G (C.I. 21220), Vulcan Fast Yellow R(C.I. 21135), Tartrazine Lake, Quinoline Yellow Lake, Anthrazane Yellow BGL (C.I. 60520), isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red F2R (C.I. 12310), Permanent Red F4R(C.I. 12335), Permanent Red FRL (C.I. 12440), Permanent Red FRLL (C.I. 12460), Permanent Red F4RH(C.I. 12420), Fast Scarlet VD, Vulcan Fast Rubine B (C.I. 12320), Brilliant Scarlet G, Lithol Rubine GX (C.I. 12825), Permanent Red F5R, Brilliant Carmine 6B, Pigment Scarlet 3B, Bordeaux 5B, Toluidine Maroon, Permanent Bordeaux F2K (C.I. 12170), Helio Bordeaux BL (C.I. 14830), Bordeaux 10B, Bon Maroon Light (C.I. 15825), Bon Maroon Medium (C.I. 15880), Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue RS(C.I. 69800), Indanthrene Blue BC (C.I. 69825), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

The content of the colorant in the toner is generally from 1 to 15% by weight, and more preferably from 3 to 10% by weight of the toner.

Colorants may be mixed with resins to be used as a masterbatch. Specific preferred examples of the resins for use as the binder resin with the masterbatch include styrene polymers and substituted styrene polymers such as polystyrene, poly-p-chlorostyrene and polyvinyltoluene; styrene copolymers such as styrene-p-chlorostyrene copolymers, styrene-vinyltoluene copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, polyacrylic resins, rosin, modified rosins, terpene resins, aliphatic or alicyclic hydrocarbon resins, aromatic petroleum resins, chlorinated paraffin, paraffin waxes, etc. These resins may be used alone or in combination.

Releasing Agent

The releasing agent used in the present invention is described as below.

As for the releasing agent, a wax dispersed in the binder resin and having a low melting point of 50 to 120° C. works as an effective releasing agent on a surface boundary between a fusing roller and a toner. With such an arrangement, a good hot-offset resistance of the toner can be observed without applying an oily material as a releasing agent to the fusing roller.

Specific preferred examples of the release agent for the present invention include waxes such as plant-based waxes including carnauba wax, cotton wax, Japanese wax, and rice wax; animal-based waxes including honey wax and lanoline; mineral-based waxes including ozokerite and selsyn; and petroleum waxes such as paraffin, microcrystalline, and petrolatum.

Besides these natural waxes, synthetic hydrocarbon waxes including Fischer-Tropsh wax and polyethylene wax, and synthetic waxes including esters, ketones, ethers may be used.

Furthermore, aliphatic acid amides such as 1,2-hydroxystearic acid amide, stearic acid amide, phthalic anhydride imide, chlorinated hydrocarbons may be used.

Other examples of the release agent include crystalline polymers having low molecular weight and long alkyl groups as a side chain such as homopolymers or copolymers of polyacrylates such as poly-n-stearyl methacrylate, poly-n-lauryl methacrylate (e.g., copolymer of n-stearyl acrylate/ethyl methacrylate).

The releasing agent may be mixed with the masterbatch and the binder resin, or may be dissolved and dispersed in an organic solvent.

External Additive

The external additive used in the present invention is described as below.

The thus prepared toner particles are optionally mixed with an external additive such as fluidity, developability, and charge property improving agents. Inorganic fine particles are typically used as the external additive (i.e., fluidity improving agent). Inorganic particulate materials having a primary particle diameter of from 5 nm to 2 μm are typically used. More preferably, the primary particle diameter is from 5 nm to 0.5 μm. The surface area of the inorganic particulate materials is preferably from 20 to 500 m²/g when measured by a BET method.

The content of the inorganic particulate material is preferably from 0.01% to 5.0% by weight, and more preferably from 0.01% to 2.0% by weight, based on the total weight of the toner.

Specific preferred examples of such inorganic particulate materials include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

More specifically, inorganic particulate used as fluidity improving agent includes hydrophobic silica fine particulate and hydrophobic titanium oxide fine particulate, and preferably a combination of them are used as an external additive.

More specifically, when fine particulates of hydrophobic silica and hydrophobic titanium oxide having an average diameter of less than 5×10⁻² μm are mixed and agitated with toners, the electrostatic force and Van der Waals force with the toners are significantly improved.

Therefore, when toners are agitated in the developing unit to obtain a desired charge level, the fluidity improving agent may not drop off from the toners. Accordingly, the white spot phenomenon can be prevented, and result in a good quality image, and furthermore the amount of toners remaining on the photoconductive drum 11 after the transferring process can be reduced.

The titanium oxide fine particulate has good properties such as environmental stability, and image concentration stability, but also has a drawback such as unfavorable effect to charge rising property of the toners. Therefore, if the amount of the titanium oxide fine particulate is larger than the amount of the silica fine particulate, such drawback may not be ignored.

However, if the amount of the titanium oxide fine particulate and the silica fine particulate is controlled from 0.3 to 1.5 wt %, the charge rising property of the toners may not be affected significantly, and a desired charge rising property can be obtained.

Accordingly, good image quality can be stably obtained when repeating copying operations.

Production Process of the Toner

Hereinafter, a preferable production process of the toner used in the present invention is described. However, the method is not limited to the following description, and other methods can be employed.

At first, a colorant (such as pigments), a unmodified polyester, a polyester prepolymer having a isocyanate group, and other additives such as release agents, charge controlling agents and the like are dissolved or dispersed in a volatile organic solvent to prepare a toner constituent mixture liquid (i.e., an oil phase liquid). The volatile solvents preferably have a boiling point lower than 100° C. so as to be easily removed after a granulating process, that is formation of mother toner particles.

Specific preferred examples of the volatile solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These solvents can be used alone or in combination.

In particular, aromatic solvents such as toluene and xylene, and halogenated hydrocarbons such as methylene chloride, 1,2-dichloroethane, chloroform and carbon tetrachloride are preferably used. The added amount of the organic solvent is generally from 0 to 300 parts, preferably from 0 to 100 parts and more preferably from 25 to 70 parts by weight, per 100 parts by weight of the polyester prepolymer.

Then, the toner constituent mixture liquid (i.e., an oil phase liquid) is emulsified in an aqueous medium with a presence of surfactant and resin fine particle.

Suitable aqueous medium includes water. In addition, other solvents, which can be mixed with water, can be used. Specific examples of such solvents include, but are not limited to, alcohols such as methanol, isopropanol, and ethylene glycol; dimethylformamide, tetrahydrofuran, cellosolves such as methyl cellosolve, lower ketones such as acetone and methyl ethyl ketone, etc.

The weight ratio of the toner constituent mixture liquid (i.e., the oil phase liquid) including a prepolymer and other toner constituents to the aqueous medium is generally from 100/50 to 100/2000, and preferably from 100/100 to 100/1000. When the amount of the aqueous medium is too small, the toner constituent mixture may not be well dispersed, and thereby a toner having a desired particle diameter cannot be prepared. In contrast, when the amount of the aqueous medium is too large, it is not economical.

To improve dispersing in the aqueous medium, a dispersing agent such as surfactant and resin fine particle is added to the aqueous medium, as required.

Specific preferred examples of the surfactants include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); non-ionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

By using a surfactant having a fluoroalkyl group, dispersability in the aqueous medium can be improved with a relatively small amount of surfactant.

Specific preferred examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11) oxy}-1-alkyl(C3-C4) sulfonate, sodium 3-{omega-fluoroalkanoyl(C6-C8)-N-ethylamino}-1-propanesulfonate, fluoroalkyl(C11-C20) carboxylic acids and their metal salts, perfluoroalkylcarboxylic(C7-C13) acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C 10)sulfoneamidepropyltrimethylammonium salts, salts of perfluoroalkyl(C6-C10)-N-ethylsulfonyl glycin, and monoperfluoroalkyl(C6-C16)ethylphosphates, etc.

Specific preferred commercially available examples of such surfactants include SARFRON® S-111, S-112 and S-113, which are manufactured by Asahi Glass Co., Ltd.; FLUORAD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-110, F-120, F-113, F-191, F-812 and F-833 which are manufactured by Dainippon Ink and Chemicals, Inc.; ECTOP® EF-102, 103, 104, 105, 112, 123A, 123B, 306A, 501, 201 and 204, which are manufactured by Tohchem Products Co., Ltd.; FUTARGENT® F-100 and F150 manufactured by Neos; etc.

Specific preferred examples of cationic surfactants having a fluoroalkyl group, which can disperse an oil phase including toner constituents in water, include primary, secondary and tertiary aliphatic amines having a fluoroalkyl group, aliphatic quaternary ammonium salts such as perfluoroalkyl(C6-C10) sulfoneamidepropyltrimethylammonium salts, benzalkonium salts, benzetonium chloride, pyridinium salts, imidazolinium salts, etc.

Specific preferred commercially available examples thereof include SARFRON® S-121 (from Asahi Glass Co., Ltd.); FLUORAD® FC-135 (from Sumitomo 3M Ltd.); UNIDYNE® DS-202 (from Daikin Industries, Ltd.); MEGAFACE® F-150 and F-824 (from Dainippon Ink and Chemicals, Inc.); ECTOP® EF-132 (from Tohchem Products Co., Ltd.); FUTARGENT® F-300 (from Neos); etc.

Suitable resins for use as fine resin particle include known resins, which can be dispersed in an aqueous medium.

Specific preferred examples thereof include thermoplastic and thermosetting resins such as vinyl resins, polyurethane resins, epoxy resins, polyester resins, polyamide resins, polyimide resins, silicone resins, phenolic resins, melamine resins, urea resins, aniline resins, ionomer resins, polycarbonate resins, etc. These resins can be used alone or in combination.

Among these resins, vinyl resins, polyurethane resins, epoxy resins and polyester resins are preferably used because an aqueous dispersion including fine spherical resin particles can be easily prepared.

Specific preferred examples of the vinyl resins include homopolymers or copolymers obtained from one or more vinyl monomers, such as styrene—(meth)acrylate copolymers, styrene—butadiene copolymers, (meth)acrylic acid—acrylate copolymers, styrene—acrylonitrile copolymers, styrene—maleic anhydride copolymers, styrene—(meth)acrylic acid copolymers, etc.

The average diameter of the fine resin particle is from 5 to 200 nm, and preferably from 20 to 300 nm.

Suitable inorganic dispersants include tricalcium phosphate, calcium carbonate, titanium oxide, colloidal silica, hydroxyapatite, etc.

Furthermore, it is possible to stably disperse toner constituents in an aqueous medium by using a polymeric protection colloid with the above-described fine resin particle and inorganic dispersant.

Specific preferred examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), (meta)acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, glycerinmonomethacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine).

In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

As the dispersing machine, known mixers and dispersing machines such as low shearing type dispersing machines, high shearing type dispersing machines, friction type dispersing machines, high pressure jet type dispersing machines and ultrasonic dispersing machine can be used.

In order to prepare a dispersion including particles having an average particle diameter of from 2 to 20 μm, high shearing type dispersing machines are preferably used.

When high shearing type dispersing machines are used, the rotation speed of the rotors is not particularly limited, but the rotation speed is generally from 1,000 to 30,000 rpm, and preferably from 5,000 to 20,000 rpm.

In addition, the dispersing time is not particularly limited, but the dispersing time is generally from 0.1 to 5 minutes. The temperature in the dispersing process is generally from 0 to 150° C. (under pressure), and preferably from 40 to 98° C.

While preparing an emulsification solution, amines (B) are combined for reaction with a polyester prepolymer (A) having an isocyanate group. Such reaction includes an extension and/or crosslinking reaction of molecular chain. The reaction time depends on reactivity between the isocyanate group of the polyester prepolymer (A) and amines (B), and is generally from 10 minutes to 40 hours, and more preferably from 2 to 24 hours. The reaction temperature is generally 0 to 150° C., and more preferably 40 to 98° C.

Furthermore, a known catalyst can be used for the reaction, as required. Specifically, dibutyltin laurate and dioctyltin laurate can be exemplified.

After the reaction, the organic solvent is removed from an emulsified dispersion to obtain a resultant product, and the product washed and dried to obtain the mother toner particles.

The organic solvent is removed by heating the reaction solution while agitating the solution. By giving a strong agitation at a certain temperature range for the reaction solution, mother toner particles having spindle shape can be prepared.

When a material such as calcium phosphate salt that can be dissolved in acid or alkali is used as a dispersing stabilizer, the calcium phosphate salt is dissolved by an acid such as hydrochloric acid, and then washed by water so that the calcium phosphate salt can be removed from the mother toner particles.

In addition, organic solvent can be removed by decomposing the organic solvent with an enzyme, for example.

A charge controlling agent is added to the above-described mother toner particle, as required, and then an inorganic fine particulate, such as silica fine particulate and titanium oxide fine particulate, is added to obtain toners. Adding of the charge controlling agent and inorganic fine particulate can be conducted by a known method using a mixer or the like. With such processes, toner having a smaller diameter and a narrower peak diameter distribution can be readily obtained.

A strong agitation, which is conducted during the organic solvent removing process, can be used for controlling a shape of toner from a spherical shape to a rugby ball shape (i.e., spindle shape). Furthermore, morphology of the surface of the toner can be controlled from a smoothing surface to a wrinkled surface.

The toner for use in the present invention preferably has a volume average particle diameter (Dv) of from 3.0 to 8.0 μm, and a ratio (Dv/Dn) (i.e., a ratio of the volume average particle diameter (Dv) to the number average particle diameter (Dn)) of from 1.10 to 1.40. When smaller diameter toners are used, such toners can be adhered to an electrostatic latent image more precisely, that is, the smaller the particle diameter of a toner, the better the resolution of the toner images.

In addition, when peak diameter distribution of the toners becomes narrower, charging distribution of toners can become more uniform. Accordingly, a high quality image having less background fogging can be obtained and transferability of toners can be improved.

In general, when the toner having too small diameter is used, the cleanability of the toner by a blade deteriorates.

However, with an application of the zinc stearate to the surface of the photoconductive drum 11 of the image forming apparatus 90 in an adequate amount, blade cleanability of the toners by the blade can be improved, and, as a result, filming can be suppressed.

The toner for use in the present invention preferably has a spherical shape that can be defined by shape factors SF-1 and SF-2 to be described later.

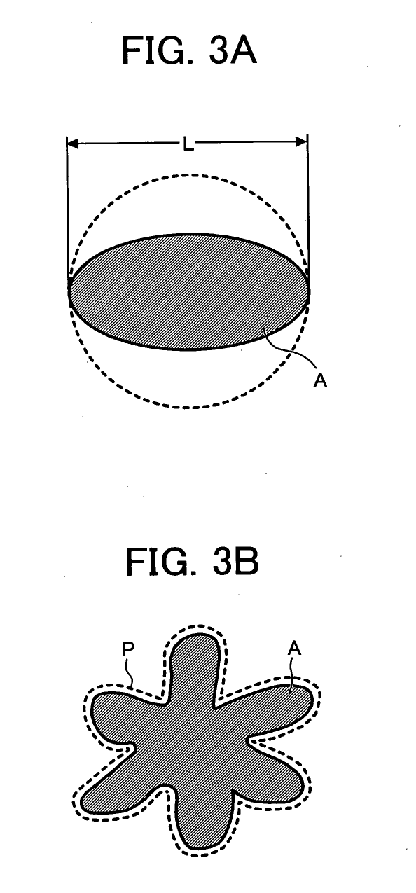

FIGS. 3A and 3B are schematic views for explaining the shape factors SF-1 and SF-2, respectively. As illustrated in FIG. 3A, the shape factor SF-1 represents the degree of roundness of a toner and is defined by the following equation (2):
SF-1={(L)²/(A)}×(100π/4) (2)
wherein “L” represents a maximum diameter of the circle circumscribing the image of a toner particle, which image is obtained by observing the toner particle projected on a plane with a microscope; and “A” represents the area of the image projected on a plane.

When the SF-1 is 100, the toner particle has a true spherical form. When the SF-1 is too large, the toner particles have irregular forms and thereby the toner has poor developability and poor transferability.

As illustrated in FIG. 3B, the shape factor SF-2 represents the degree of the concavity and convexity of a toner particle, and is defined by the following equation (3):
SF-2={(P)²/(A)}×(100/4π) (3)
wherein “P” represents the peripheral length of the image of a toner particle, projected on a plane, observed by a microscope; and “A” represents the area of the image projected on a plane.

When the SF-2 approaches 100, the toner particles have a smooth surface (i.e., the toner has few concavity and convexity). It is preferable for a toner to have a slightly roughened surface because the toner has good cleanability. However, when the SF-2 is too large (i.e., the toner particles are seriously roughened), a toner scattering problem, in that toner particles are scattered around a toner image, is caused, resulting in deterioration of the toner image qualities.

Specifically, the shape factors SF-1 and SF-2 are determined by the following method:
1) particles of a toner are photographed using a scanning electron microscope (such as the S-800, manufactured by Hitachi Ltd.); and
2) photograph images of 100 toner particles are analyzed using an image analyzer (such as LUZEX 3 manufactured by Nireco Corp.) to determine the SF-1 and SF-2.

When the SF-1 is 100, the toner particle has a true spherical form. In this case, the toner particles contact the other toner particles or the photoconductive drum 11 (i.e., image carrier) at one point. Therefore, adhesion of the toner particles to the other toner particles or the photoconductive drum 11 decreases, resulting in increase of the fluidity of the toner particles and the transferability of the toner.

However, a toner particle having a true spherical shape is likely to pass through the tiny spaces formed between the cleaning blade 15a and the photoconductive drum 11. Therefore, the toner for use in the present invention preferably has the shape factor SF-1 of 100 or more and the shape factor SF-2 of 100 or more. On one hand, if the SF-1 and SF-2 becomes too large, drawbacks happen as described above, resulting in a degradation of the image quality. Accordingly, the toner for use in the present invention preferably has the shape factor SF-1 of from 100 to 180 and the shape factor SF-2 of from 100 to 180.

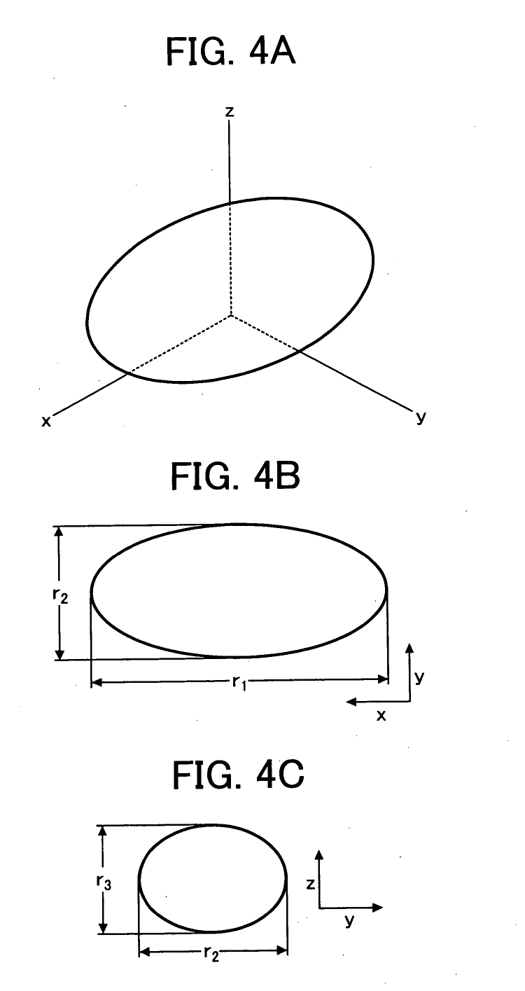

FIGS. 4A, 4B, and 4C are schematic views of toner shape according to an exemplary embodiment of the present invention.

The toner for use in the present invention preferably has a form similar to the spherical form, and preferably satisfies the following relationship:
0.5≦(r2/r1)≦1.0 and 0.7≦(r3/r2)≦1.0,
wherein r1, r2 and r3 represent the average major axis diameter of toner particle, the average minor axis diameter of toner particle and the average thickness of toner particle, wherein r3≦r2≦r1. When the ratio (r2/r1) is too small, the toner has a form far away from the spherical form, and therefore the toner has good cleanability, but the dot reproducibility and transfer efficiency deteriorate, resulting in deterioration of image qualities. In contrast, when the ratio (r2/r1) is too large, the toner has a form near the spherical form and therefore the cleaning problem tends to occur, particularly, under low temperature and low humidity conditions.

When the ratio (r3/r2) is too small, the toner has a flat form and therefore the toner does not cause the toner scattering problem because of being similar to a toner having an irregular form. However, such a toner is inferior to a spherical toner in transferability. In particular, when the ratio (r3/r2) is 1.0, the toner easily rotates on its major axis, resulting in improvement of the fluidity of the toner. Therefore the toner has good transferability and can produce high quality images.

The above-mentioned size factors (i.e., r1, r2 and r3) of toner particles can be determined by observing the toner particles with a scanning electron microscope while the viewing angle is changed.

Hereinafter, an exemplary embodiment of the present invention is described in detail. The term “part” in the following descriptions represents a weight ratio.

The toners for use in the present invention was prepared as below.

Preparation of Unmodified Polyester Resin

The following components are contained in a reaction container equipped with a condenser, a stirrer and a nitrogen introducing tube to perform a polycondensation reaction for 8 hours at 230° C. under normal pressure.
Adduct of bisphenol A with 2 mole of ethylene oxide: 724 parts,
Terephthalic acid: 276 parts, and
Dibutyl tin oxide: 2 parts.

Then the reaction is further continued for 5 hours under a reduced pressure of from 10 to 15 mmHg. Thus, an unmodified polyester resin having a peak molecular weight of 4,800 is prepared.

Then 10 parts of trimellitic anhydride are added thereto, and the mixture reacted for 2 hours at 200° C. under a reduced pressure of from 10 to 15 mmHg to replace the hydroxyl group at the end portion of the resin with a carboxyl group.

One hundred (100) parts of the thus prepared polyester resin are dissolved in 100 parts of ethyl acetate to prepare an ethyl acetate solution of the binder resin.

A part of the resin solution is dried to solidify the polyester resin. The polyester resin has a glass transition temperature of 62° C., and an acid value of 32 mgKOH/g.

Preparation of Polyester Prepolymer Having Isocyanate Group at its End Portion

The following components are contained in a reaction vessel equipped with a condenser, a stirrer and a nitrogen introducing tube and reacted for 8 hours at 230° C. under normal pressure.
Adduct of bisphenol A with 2 mole of ethylene oxide: 724 parts,
Isophthalic acid: 276 parts, and
Dibutyl tin oxide: 2 parts.

Then the reaction is further continued for 5 hours under a reduced pressure of from 10 to 15 mmHg, followed by cooling to 160° C. Further, 32 parts of phthalic anhydride are added thereto to perform a reaction for 2 hours at 160° C.

After being cooled to 80° C., the reaction product is reacted with 188 parts of isophorone diisocyanate in ethyl acetate for 2 hours. Thus, a polyester prepolymer having an isocyanate group is prepared.

Preparation of Ketimine Compound

In a reaction vessel equipped with a stirrer and a thermometer, 170 parts of isophorone diamine and 75 parts of methyl ethyl ketone are contained and reacted for 5 hours at 50° C. to prepare a ketimine compound. The ketimine compound has an amine value of 418 mgKOH/g.

Preparation of Resin Particle Dispersion

In a reaction vessel equipped with a stirrer and a thermometer, 683 parts of water, 11 parts of a sodium salt of sulfate of an ethylene oxide adduct of methacrylic acid (ELEMINOL RS-30 from Sanyo Chemical Industries Ltd.), 138 parts of styrene, 138 parts of methacrylic acid, and 1 part of ammonium persulfate are contained. The mixture is agitated for 15 minutes while the stirrer is rotated at a revolution of 400 rpm. As a result, a milky emulsion is prepared. Then the emulsion is heated to 75° C. to react the monomers for 5 hours.

Further, 30 parts of a 1% aqueous solution of ammonium persulfate are added thereto, and the mixture aged for 5 hours at 75° C. Thus, an aqueous dispersion of a vinyl resin (i.e., a copolymer of styrene/methacrylic acid/sodium salt of sulfate of ethylene oxide adduct of methacrylic acid, hereinafter referred to as particulate resin dispersion (RD)) is prepared.

The volume-average particle diameter of the particles in the particulate resin dispersion (RD), which is measured by an instrument LA-920 from Horiba Ltd., is 105 nm.

200 parts of the ethyl acetate solution of the unmodified polyester resin prepared above, 5 parts of a carnauba wax, and 4 parts of a copper phthalocyanine pigment are fed into a ball mill pot including zirconia balls having a diameter of 5 mm to be subjected to ball milling for 24 hours. Then, 20 parts of the polyester prepolymer having isocyanate group are added to prepare a toner constituent mixture liquid.

On the other hand, 20 parts of the resin dispersion prepared as above and 3 parts of sodium dodecylbenzenesulfonate are dissolved and dispersed in 600 parts of deionized water contained in a beaker. The mixture is agitated by a T. K. ROBOMICS® from Tokushu Kika Kogyo Co., Ltd. while the rotor of T. K. ROBOMICS® is rotated at a revolution of 15,000 rpm and the temperature of the mixture maintained at 20° C. Then the toner constituent mixture liquid prepared above is added thereto with 1 part of ketimine compound, and the mixture agitated for 3 minutes to prepare an emulsion.

Then the emulsion is transferred to a flask equipped with a stirrer and a thermometer, followed by heating for 8 hours at 30° C. under a reduced pressure of 50 mmHg. Thus, the solvent (i.e., the ethyl acetate) is removed from the emulsion, resulting in preparation of a dispersion. It is confirmed by gas chromatography that the content of ethyl acetate is not higher than 100 ppm in the dispersion.

The thus prepared cake is dispersed in distilled water to be washed, followed by filtering. This washing operation is performed three times. The thus prepared cake is dispersed again in distilled water so that the solid content is 10% by weight, to prepare a dispersion including toner constituent particles.

It is confirmed from observation of the toner particles with a scanning electron microscope (SEM) that the resin particle having a particle diameter of 150 nm is uniformly adhered to the surface of the toner particles.

Then, 1% by weight aqueous solution of N,N,N-trimethyl-[3-(4-perfluorononenyloxybenzamide)propyl]ammonium iodide (i.e., FUTARGENT 310, from Neos) is added to the dispersion solution so that the amount of the N,N,N-trimethyl-[3-(4-perfluorononenyloxybenzamide)propyl]ammonium iodide becomes 0.2% by weight relative to the toner particles.

The mixture is agitated for 1 hour at room temperature, followed by filtering and drying of the resultant cake at 40° C. for 24 hours. Thus, toner particles having received a surface treatment are prepared.

One hundred (100) parts of the thus prepared toner particles are mixed with 0.5 parts of a hydrophobized silica and 0.5 parts of a hydrophobized titanium oxide using a HENSCHEL mixer. Thus, a toner used in the present invention is prepared.

It is confirmed that the volume average diameter of the toner used in the present invention is 4.9 μm and the average sphericity of the toner is 0.96.

5 parts of the thus prepared toner and 95 parts of carrier particle (described below) are mixed with a blending machine for 10 minutes, and then the developing agent prepared.

Preparation of the Carrier Particle

Core material: spherical ferrite particle having an average diameter of 50 μm,
Coating material: silicone resin with aminosilane coupling agent

The silicone resin and the aminosilane coupling agent are dispersed in toluene. Thus prepared solution is heated and sprayed to the above-mentioned core material. The sprayed core material is baked and cooled. Thus, carrier particles having average coating film thickness of 0.2 μm of the resin are prepared.

### EXAMPLES

### Example 1

The prepared developing agent was set in the developing unit of the image forming apparatus 90 shown in FIG. 1. The lubrication agent block 17a (i.e. zinc stearate block) was biased to the cleaning brush 15b with a biasing pressure of 500 mN, and the circumferential speed ratio for the cleaning brush 15b and the photoconductive drum 11 was set to 1.0 to conduct image forming.

### Comparative Example 1

Similar settings as in the Example 1 were used for Comparative Example 1 to conduct image forming, except that the biasing pressure for biasing the lubrication agent block 17a to the cleaning brush 15b was set to 0 mN.

After conducting the image forming process for a predetermined number of sheets in Example 1 and Comparative Example 1, the surface of the photoconductive drum was evaluated with following methods.

Evaluation Methods

1) Determination of Zinc Amount on the Surface of the Photoconductive Drum

After outputting 100 sheets, in which a band of 0%-image-written-area portion and a band of 100%-image-written-area portion are included, the surface of the photoconductive drum 11 was analyzed by an XPS method using the AXIS-ULTRA® (from Shimadzu Corporation) to determine zinc amount on the surface of the photoconductive drum 11.

2) Cleanability Evaluation

After outputting 1,000 sheets, in which a band of 5%-image-written-area portion is included, Scotch Tape (trade name), made by Sumitomo 3M Limited, was taped on the surface of the photoconductive drum 11 which received a cleaning process, and the Scotch Tape peeled off to transfer remaining toners on the surface of the photoconductive drum 11 to a white sheet. The density of the remaining toners on the white sheet was measured using a Macbeth reflection densitometer RD 514. The evaluation was conducted by comparing differences between each sample of Example 1 or Comparative Example 1 and a blank sample (i.e., standard sample) as below.
A: density difference is less than 0.005,
B: density difference is from 0.005 to 0.010,
C: density difference is from 0.011 to 0.02,
D: density difference is more than 0.02.
   3) Observation of Filming

After outputting 1,000 sheets, in which a band of 5%-image-written-area portion is included, sheets having 100%-image-written-area portion were output. The filming on the surface of the photoconductive drum 11 was evaluated by a visual inspection of white patch in printed images.

The evaluation results of the surface of the photoconductive drum 11 are shown in Table 1.

TABLE 1

| | | | Zinc | | |
|---|---|---|---|---|---|
| | | | amount | | |
| | Band chart | | (atm %) | Cleanability | Filming |
| Example 1 | Image | 100% | 1.26 | A | Not observed |
| | area | 0% | 0.40 | | |
| | portion | | | | |
| Comparative | Image | 100% | 0.30 | D | Observed |
| Example 1 | area | 0% | 0.15 | | |
| | portion | | | | |

As shown in Table 1, in the Example 1, the zinc amount on the surface of the photoconductive drum 11 after outputting 100 sheets having 0%-image-written-area portion and 100%-image-written-area portion was 0.4 atm % or more. In this case, the cleanability of the surface of the photoconductive drum 11 was evaluated as “A” (i.e., favorable result), and the filming was not observed.

On the other hand, in the Comparative Example 1, the zinc amount on the surface of the photoconductive drum 11 after outputting 100 sheets having 0%-image-written-area portion and 100%-image-written-area portion was lower than 0.4 atm %. In this case, the cleanability of the surface of the photoconductive drum was evaluated as “D” (i.e., unfavorable result), and filming was also observed.

Numerous additional modifications and variations are possible in light of the above teachings. It is therefore to be understood that within the scope of the appended claims, the disclosure of the present invention may be practiced otherwise than as specifically described herein.

This application claims priority from Japanese patent application No. 2004-091310 filed on Mar. 26, 2004 in the Japan Patent Office, the entire contents of which are hereby incorporated by reference herein.

1. An image forming apparatus, comprising:
an image carrier;
a cleaning mechanism having a cleaning blade configured to clean materials including a toner remaining on a surface of the image carrier; and
an application mechanism configured to apply a lubrication agent on the surface of the image carrier,
wherein the toner is free from zinc and has an average circularity of at least 0.93, the lubrication agent comprises zinc stearate, and a zinc amount on the surface of the image carrier after a cleaning process by the cleaning mechanism and an application process by the application mechanism is from 0.4 to 2.5 atm %.

2. An image forming apparatus, comprising:
an image carrier;
a charging unit configured to charge the image carrier;
an exposing unit configured to expose a surface of the image carrier to write an electrostatic latent image on the surface of the image carrier;
a developing unit configured to supply a toner to the electrostatic latent image to make visible the electrostatic latent image;
a transfer unit configured to transfer the visible image to a recording medium;
a cleaning mechanism having a cleaning blade configured to clean the surface of the image carrier after transferring the visible image to the recording medium; and
an application mechanism configured to apply a lubrication agent on the surface of the image carrier after transferring the visible image to the recording medium,
wherein the toner is free from zinc and has an average circularity of at least 0.93, the lubrication agent comprises zinc stearate, and a zinc amount on the surface of the image carrier after a cleaning process by the cleaning mechanism and an application process by the application mechanism is from 0.4 to 2.5 atm %.

3. The image forming apparatus according to claim 2, wherein the application mechanism comprises a lubrication agent block formed of the lubrication agent, a biasing device, and an application roller.

4. The image forming apparatus according to claim 3, wherein the application roller is configured to scrape the lubrication agent from the lubrication agent block and apply the scraped lubrication agent on the surface of the image carrier.

5. The image forming apparatus according to claim 3, wherein the application roller comprises a brush-type roller.

6. The image forming apparatus according to claim 3, wherein the biasing device comprises a spring.

7. The image forming apparatus according to claim 3, wherein the biasing device biases the lubrication agent block to the application roller with a pressure of from 200 to 3,000 mN.

8. The image forming apparatus according to claim 3, wherein the image carrier and the application roller have a circumferential speed ratio of from 0.8 to 1.2, wherein the circumferential speed ratio is calculated by dividing a circumferential speed of the image carrier with a circumferential speed of the application roller.

9. The image forming apparatus according to claim 2, wherein the toner comprises a negatively-charged toner.

10. The image forming apparatus according to claim 9, wherein the negatively-charged toner is obtained by treating a surface of a mother toner particle in a solution comprising a fluorinated compound.

11. The image forming apparatus according to claim 10, wherein the fluorinated compound comprises a surfactant having a polarity different from a polarity of the surface of the mother toner particle before the treatment.

12. The image forming apparatus according to claim 10, wherein the fluorinated compound is a compound of formula (1): 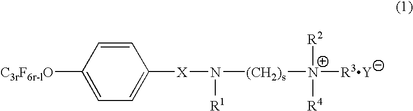
wherein X represents —SO₂— or —CO—, R¹ to R⁴ each, independently, represent hydrogen atom, a lower alkyl group or an aryl group having 1 to 10 carbon atoms, Y represents I or Br, and r and s each, independently, represent a whole number of from 1 to 20.

13. The image forming apparatus according to claim 1, wherein the toner is prepared by a method comprising:
dissolving or dispersing at least a polyester prepolymer having a functional group containing a nitrogen atom, a polyester, a coloring agent, and a releasing agent in an organic solvent to prepare a toner constituent mixture liquid; and
dispersing the toner constituent mixture liquid in an aqueous medium while subjecting the polymer to at least one of an extension reaction and a crosslinking reaction.

14. The image forming apparatus according to claim 1, wherein the toner has a volume average diameter of from 3 to 8 μm, and a ratio (Dv/Dn) of volume average diameter (Dv) to number average diameter (Dn) of the toner is from 1.00 to 1.40.

15. The image forming apparatus according to claim 1, wherein the toner has a first shape factor, SF-1, of from 100 to 180, and a second shape factor, SF-2, of from 100 to 180.

16. The image forming apparatus according to claim 1, wherein the toner has a substantially spherical shape, and satisfies a relationship of 0.5≦(r2/r1)≦1.0 and 0.7≦(r3/r2)≦1.0, wherein r1, r2 and r3 represent an average major axis diameter of toner particle, an average minor axis diameter of toner particle and an average thickness of toner particle, respectively, and r1, r2 and r3 have a relationship of r3≦r2≦r1.

17. An image forming apparatus, comprising:
means for carrying;
means for charging a surface of the means for carrying;
means for exposing the surface of the means for carrying to write an electrostatic latent image on the surface of the means for carrying;
means for supplying one or more toners to the electrostatic latent image to develop the electrostatic latent image;
means for transferring the visible image to a recoding medium;
means for cleaning the surface of the image carrier after transferring the visible image to the recoding medium; and
means for applying a lubrication agent on the surface of the means for carrying after transferring the visible image to the recoding medium,
wherein the toner is free from zinc and has an average circularity of at least 0.93, the lubrication agent comprises zinc stearate, and a zinc amount on the surface of the means for carrying after a cleaning process by the means for cleaning and an application process by the means for carrying applying is from 0.4 to 2.5 atm %.

18. A method of applying a lubrication agent for use in an image forming apparatus including an image carrier, a cleaning mechanism, and an application mechanism, the method comprising:
applying a lubrication agent on the surface of the image carrier with the application mechanism comprising a lubrication agent block, an application roller, and a biasing device; and
cleaning a surface of the image carrier with the cleaning mechanism comprising a blade,
wherein the biasing device biases the lubrication agent block to the application roller with a pressure of from 200 to 3,000 mN, the lubrication agent in the lubrication agent block comprises zinc stearate, and a zinc amount on the surface of the image carrier after the cleaning step and the applying step is from 0.4 to 2.5 atm %.

19. The method according to claim 18, wherein the application roller is configured to scrape the lubrication agent from the lubrication agent block and apply the scraped lubrication agent on the surface of the image carrier, and comprises a brush-type roller.

20. The method according to claim 18, wherein the biasing device comprises a spring.

21. The method according to claim 18, wherein the image carrier and the application roller have a circumferential speed ratio of from 0.8 to 1.2, wherein the circumferential speed ratio is calculated by dividing a circumferential speed of the image carrier with a circumferential speed of the application roller.

22. A process cartridge detachably provided to an image forming apparatus, comprising:
an image carrier configured to carry an electrostatic latent image thereon;
a developing unit configured to supply a toner to the electrostatic latent formed on a surface of the image carrier, and make visible the electrostatic latent image;
a cleaning mechanism configured to clean the surface of the image carrier after transferring the visible image to a recording medium; and
an application mechanism configured to apply a lubrication agent on the surface of the image carrier after transferring the visible image to a recording medium,
wherein the toner is free from zinc and has an average circularity of 0.93 or more, the lubrication agent comprises zinc stearate, and a zinc amount on the surface of the image carrier after a cleaning process by the cleaning mechanism and an application process by the application mechanism is from 0.4 to 2.5 atm %.

23. A toner for use in an image forming apparatus, comprising:
a resin; and
a colorant,
wherein the toner is free from zinc and has an average circularity of at least 0.93.

24. The toner according to claim 23, wherein the toner is a negatively-charged toner.

25. The toner according to claim 24, wherein the negatively-charged toner is prepared by treating a surface of a mother toner particle in a solution containing a fluorinated compound.

26. The toner according to claim 25, wherein the fluorinated compound used for the treatment of the surface of the mother toner particle comprises a surfactant having a polarity different from a polarity of the surface of the mother toner particle before the treatment.

27. The toner according to claim 25, wherein the fluorinated compound is a compound of formula (1): 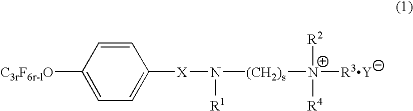
wherein X represents —SO₂— or —CO—, R¹ to R⁴ each, independently, represent hydrogen atom, a lower alkyl group or an aryl group having 1 to 10 carbon atoms, Y represents I or Br, and r and s each, independently, represent a whole number of 1 to 20.

28. The toner according to claim 23, wherein the toner is prepared by a method comprising:
dissolving or dispersing at least a polyester prepolymer having a functional group containing a nitrogen atom, a polyester, a coloring agent, and a releasing agent in an organic solvent to prepare a toner constituent mixture liquid; and
dispersing the toner constituent mixture liquid in an aqueous medium while subjecting the polymer to at least one of an extension reaction and a crosslinking reaction.

29. The toner according to claim 23, wherein the toner has a volume average diameter of from 3 to 8 μm, and a ratio (Dv/Dn) of volume average diameter (Dv) to number average diameter (Dn) of the toner is from 1.00 to 1.40.

30. The toner according to claim 23, wherein the toner has a first shape factor, SF-1, of from 100 to 180, and a second shape factor, SF-2, of from 100 to 180.

31. The toner according to claim 23, wherein the toner has a substantially spherical shape, and satisfies a following relationship of 0.5≦(r2/r1)≦1.0 and 0.7≦(r3/r2)≦1.0, wherein r1, r2 and r3 represent an average major axis diameter of toner particle, an average minor axis diameter of toner particle and an average thickness of toner particle, respectively, wherein r1, r2 and r3 have a relationship of r3≦r2≦r1.
